(19) United States
(12) Patent Application Publication
(10) Pub. No.: US 2011/0018231 A1
(43) Pub. Date: Jan. 27, 2011

(54) Steering Arrangement for a Trailer

(75) Inventor: Hans Friedrich COLLENBERG, Wallenhorst (DE)

Correspondence Address: Hildebrand, Christa;Norris McLaughlin & Marcus PA, 875 Third Avenue, 8th Floor, New York, NY, 10022, US

(73) Assignee: ZF FRIEDRICHSHAFEN AG, Friedrichshafen (DE)

(21) Appl. No.: 12/839,109

(22) Filed: Jul. 19, 2010

(30) Foreign Application Priority Data
Jul. 24, 2009 (DE) 10 2009 028 000.6

(51) Int. Cl. B62D 6/04

(52) U.S. Cl. 280/448

(57) ABSTRACT

Steering arrangement for a trailer, with a hitch (8) connected with a chassis (17) of the trailer (2), a trailer coupling (4), by which the hitch (8) can be coupled to a tractor (1) in an articulated fashion by forming a composition (3) comprising the tractor (1) and the trailer (2), a drive (24) which is at least indirectly coupled with the trailer coupling (4), by which the articulation angle (α) of the composition (3) can be varied during reverse travel, and a controller (25) coupled with the drive (24), by which the drive (24) can be controlled, wherein the hitch (8) is supported on the chassis (17) for movement in the transverse direction (16) of the trailer (2) and is movable by the drive (24) in this direction relative to the chassis (17).

### CROSS-REFERENCE TO RELATED APPLICATION

This is an application claims priority to German Application DE 10 2009 028 000.6 filed Jul. 24, 2009.

### BACKGROUND OF THE INVENTION

(1) Field of the Invention

The invention relates to a steering arrangement for a trailer, with a hitch connected with a chassis of the trailer, a trailer coupling, by which the hitch can be coupled to a tractor in an articulated fashion by forming a composition comprising the tractor and trailer, a drive which can be at least indirectly coupled with the trailer hitch, with which the articulation angle of the composition can be varied during reverse travel, and a controller coupled with the drive, by which the drive can be controlled.

(2) Description of Related Art

During reverse travel of a composition consisting of a truck and a trailer, the trailer must be kept on track, requiring the tractor driver to perform complicated steering maneuvers. This applies in particular, but not exclusively, to single-axle trailers. Several approaches are available to stabilize the trailer during reverse travel by active intervention. According to a first approach, an active intervention in the tractor steering takes place (active steering). However, this solution depends on the standard equipment of the tractor. According to a second approach, the trailer hitch is actively moved on the tractor in the transverse direction. The solution is rather complex and visually unacceptable. According to a third approach, the trailer axle is actively steered. This solution is also complex, because it requires the chassis of the trailer to be altered and does not represent a satisfactory retrofit solution for trailers lacking a steerable axle, such as single-axle trailers.

DE 195 13 744 A1 describes a trailer coupling for a tractor, which is arranged for displacement along a substantially horizontal axis oriented perpendicular to the pulling direction. The trailer coupling, which is, for example, arranged on the rearward side of a truck, can be hydraulically moved on a spindle. Also provided is a controller with which the position of the trailer coupling on the rearward of the tractor can be varied.

DE 10 2007 048 069 A1 discloses an apparatus for moving and switching a trailer, wherein the towing apparatus is movable in the transverse direction, thereby allowing steering of the trailer. The towing apparatus is provided on the rearward side of a tractor and includes a hydraulic cylinder and a pulling jaw, which can be moved in the transverse direction by a hydraulic cylinder. Switching of the trailer can be performed automatically. For example, substantial directional changes in a curve can be predetermined by the steering system of the tractor, wherein fine adjustment is then performed with the transversely movable towing apparatus. For this purpose, sensors for measuring the orientation of the trailer are provided on the tractor. The towing apparatus can also be provided on the rearward side of a trailer, if several trailers are employed.

DE 10 2004 026 794 A1 discloses a tractor with a trailer coupling, wherein the trailer coupling is movable relative to the tractor in the longitudinal direction of the tractor. A drive, which is controlled by an electronic control device, is provided for moving the trailer coupling.

Based on this concept, it is an object of the invention to provide a relatively inexpensive steering arrangement, which has little effect, both visually and technically, on the tractor, and by which the trailer can be stabilized during reverse travel.

### BRIEF SUMMARY OF THE INVENTION

This object is attained according to the invention with a steering arrangement according to claim 1. Advantageous embodiments of the invention are recited in the dependent claims.

The steering arrangement of the invention for a trailer includes a hitch connected with a chassis of the trailer, a trailer coupling, by which the hitch can be coupled in an articulated fashion to a tractor by forming a composition which includes the tractor and the trailer, a drive which is at least indirectly coupled with the trailer coupling, with which the articulation angle of the composition can be varied during reverse travel, and a controller coupled with the drive, with which the drive can be controlled, wherein the hitch is supported on the chassis for movement in the transverse direction of the trailer and can be moved by the drive in this direction relative to the chassis.

The articulation angle of the composition can be varied by moving the hitch relative to the chassis of the trailer in the transverse direction, so that the trailer can be stabilized during reverse travel by the controller. The steering arrangement of the invention can be implemented without requiring substantial structural changes on the tractor or any changes at all, and without adversely affecting the visual appearance of the tractor. Moreover, modern tractors are already equipped with sensors that acquire information about the angle of the steering wheel, the direction of travel, the speed and/or other quantities characteristic for the driving condition of the tractor, so that supplying such information to the controller is technically not very complex. In particular, the steering arrangement of the invention can be implemented relatively cost-effectively with trailers lacking a steerable axle, such as single-axle trailers, because no intervention in the chassis of the trailer is required.

The articulation angle of the composition refers to an angle enclosed between the longitudinal axis of the tractor and the longitudinal axis of the trailer, preferably in a plane parallel to the road surface.

Preferably, one or several control signals can be supplied to the controller, so that the hitch can be moved by the drive in the transverse direction responsive to the control signal(s). The control signal(s) preferably include(s) one or more direction signals, from which a desired articulation angle (nominal articulation angle) of the composition can be deduced. In particular, the direction signals include information about one or more quantities characterizing the driving condition of the tractor, such as its steering wheel angle, travel direction, speed and/or wheel steering angle.

In particular, the steering arrangement has an articulation angle sensor coupled with the controller, by which the actual articulation angle of the composition (actual articulation angle) can be measured and a sensor signal characterizing the actual articulation angle can be supplied as one of the control signals to the controller. The articulation angle can thereby be controlled with the controller, so that preferably the hitch is movable with the drive in the transverse direction depending on a deviation between the actual and the desired articulation angle. Preferably, the articulation angle can therefore be controlled by the controller.

The articulation angle sensor is located, in particular, on or in the trailer coupling. The articulation angle sensor preferably includes a magnetic field-sensitive sensor and a magnet which is movable relative to the sensor, wherein one of the sensor or magnet can be or is non-rotatably coupled with the chassis of the tractor, whereas the other is coupled with the hitch. Such articulation angle sensors are known, for example, from DE 103 34 000 A1 and U.S. Pat. No. 6,956,468 B2.

According to another embodiment of the invention, the steering arrangement includes an acquisition device coupled with the controller, with which information for computing a desired travel direction of the arrangement during reverse travel can be acquired and transmitted to the controller in form of one or more direction signals. The information for computing a desired travel direction of the composition during reverse travel include in particular information about the steering wheel angle of the tractor, which can be measured with a steering wheel angle sensor arranged in the tractor. In particular, the steering wheel angle corresponds to the rotation or the turn of the steering wheel of the tractor and hence indicates the travel direction desired by the operator. A steering wheel angle sensor is typically installed in modern tractors, so that the information about the steering wheel angle can be obtained from the measuring device and/or the controller with little technical complexity. The steering wheel angle sensor can be arranged external of the measuring device. Preferably, however, the acquisition device includes the steering wheel angle sensor or is formed by the steering wheel angle sensor. In particular, the acquisition device is arranged in the tractor and/or in the trailer.

Alternatively or in addition to the information about the steering wheel angle of the tractor, the direction signal(s) may also include information about the speed of the tractor, which may be measured with a speed sensor arranged in the tractor, the travel direction of the tractor, which can be measured with a travel direction sensor arranged in the tractor or with the speed sensor, one or more wheel steering angles of the tractor, which can be measured with one or more wheel steering angle sensors arranged in the tractor, and/or other quantities characterizing the driving condition of the tractor.

The drive is preferably self-locking, so that the hitch is unable to move unintentionally due to outside forces. Alternatively or in addition, a brake may be provided to prevent unintentional movement of the hitch. The drive is preferably an electric drive and includes, for example, an electric motor. Instead of an electric motor, the drive may also include hydraulic or pneumatic actuators. Preferably, the drive has a gear which couples, the example, the electric motor or one of the other actuators to the hitch. The gear includes, in particular, a worm gear enabling, for example, self-locking of the drive.

In particular, the tractor is a motor vehicle. For example, the tractor may be a light commercial vehicle or delivery truck, or a delivery van or a passenger vehicle. Preferably, the trailer lacks a steerable vehicle axle. In particular, the trailer is a single-axle trailer. Alternatively, the trailer may also include a double axle, as implemented in many mobile homes.

According to one embodiment of the invention, the trailer coupling includes a hitch ball mounted on the tractor and a coupling lock mounted on the hitch, in which the hitch ball can be inserted. The hitch ball is preferably mounted on the chassis of the tractor.

The steering arrangement according to the invention can be used with many different tractors, because no or only a few structural changes are required on the tractor. The steering arrangement of the invention can therefore be viewed as being independent of the actual type of the tractor. In addition, the steering arrangement of the invention can be manufactured at relatively low cost. The steering arrangement of the invention is also suitable for retrofitting.

### BRIEF DESCRIPTION OF THE SEVERAL VIEWS OF THE DRAWINGS

A preferred embodiment of the invention will now be described with reference to the drawing. The drawing shows in:

FIG. 1 a top view onto a composition with a steering arrangement according to an embodiment of the invention;

FIG. 2 a cross-sectional view through the trailer coupling illustrated in FIG. 1 taken along the line A-A;

FIG. 3 a schematic block diagram of electronic components of the steering arrangement; and

FIG. 4 a cross-sectional view of a modified trailer coupling taken along the line A-A.

### DETAILED DESCRIPTION OF THE INVENTION

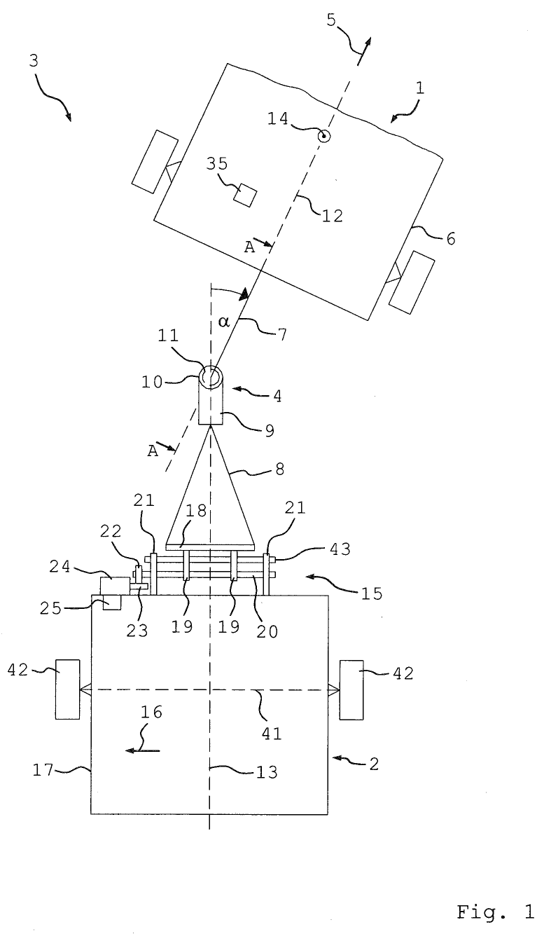

FIG. 1 shows a top view on a combination 3 formed of a tractor 1 and a trailer 2, wherein the tractor 1 is connected with the trailer 2 by way of a trailer coupling 4 in an articulated fashion. The reference symbol 5 indicates the conventional forward travel direction of the tractor 1. The trailer coupling 4 includes a coupling member 7 which is rigidly connected with the chassis 6 of the tractor and a coupling lock 9 which is attached to the hitch 8 of the trailer 2. The coupling lock 9 includes a ball socket 10, in which a schematically illustrated hitch ball 11 arranged on the rearward end of the coupling member 7 is located, as viewed in the travel direction 5. The coupling lock 9 also forms a forward end of the hitch 8, as viewed in the travel direction 5.

The angle α between the longitudinal axis 12 of the tractor 1 and the longitudinal axis 13 of the trailer 2 forms the so-called articulation angle of the composition 3. The articulation angle α is, in particular, located in a plane perpendicular to the vertical vehicle direction 14 of the tractor 1, wherein the vertical vehicle direction 14 in FIG. 1 extends perpendicular to the drawing plane.

The hitch 8 is supported on the chassis 17 of the trailer 2 for displacement in the transverse direction 16 of the trailer 2 and can be moved in the transverse direction 16 with a spindle drive 15. The hitch 8 has at its rearward end, as viewed in the direction of travel 5, a carriage 18, on which retaining members 19 are attached, which are screwed onto the spindle 20. In addition, the retaining members 19 are arranged on a guide 43 for displacement in the transverse direction 16, wherein the guide 43 is supported by bearings 21 attached on the chassis 17 which absorb forces transverse to the spindle axle. The spindle 20 is supported on the chassis 17 for rotation about its longitudinal axis by the bearings 21. A gear wheel 22 is non-rotatably connected with the spindle 20 and meshes with a worm 23 that can be driven by an electric motor 24. The gear wheel 22 and the worm 23 therefore form a worm gear. The electric motor 24 is attached on the chassis 17 and can be controlled by a controller 25 provided on the trailer 2. When the motor 24 is controlled by the controller 25 to turn the worm 23, the spindle 20 is rotated about its longitudinal axis by the intervening gear wheel 22. Because the longitudinal axis of the spindle 20 extends in the transverse direction 16, the retaining members 19 are moved by the rotating spindle 20 in the transverse direction 16 and displace the carriage 18 and hence the hitch 8 relative to the chassis 17 in the transverse direction 16. This changes the articulation angle α.

The hitch 8 can be displaced relative to the chassis 17 back-and-forth in the transverse direction, meaning in the direction of the arrow 16 and in the opposite direction. The direction of the displacement of the hitch 8 in the transverse direction can therefore be controlled with the controller 25.

The trailer 2 has a non-steerable vehicle axle 41 extending in the transverse direction 16 with two wheels 42 and is in this embodiment constructed as a single-axle trailer. Alternatively, the trailer 2 may also have several vehicle axles.

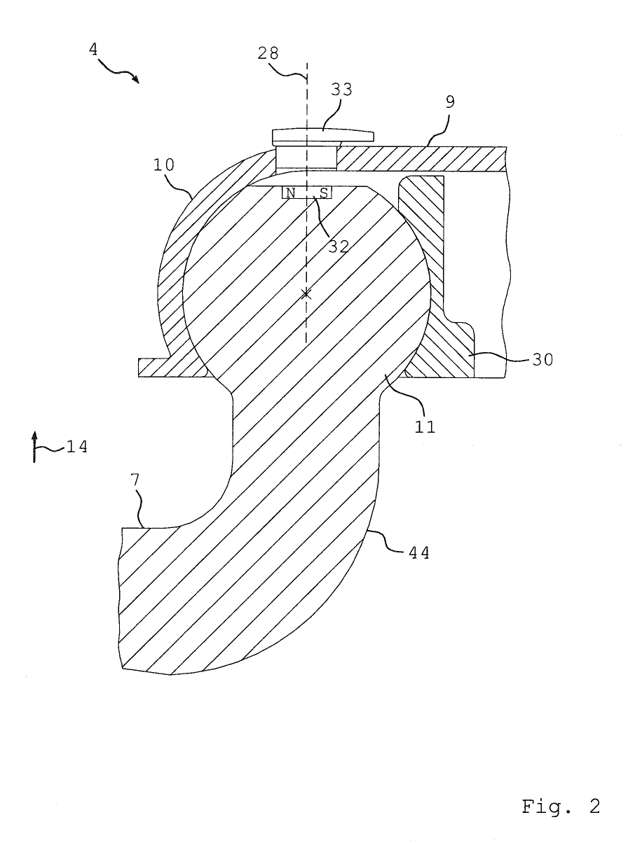

FIG. 2 shows schematically a side view of the trailer coupling 4 along the longitudinal axis 12 and in the vertical vehicle direction 14, wherein the hitch ball 11 is rigidly connected with the coupling member 7. The hitch ball 11 is located at the end of a section 44 of the coupling member 7 which is curved upwardly in the direction of the vertical axis 14 and is formed as a single piece therewith. Alternatively, the hitch ball 11 may also be manufactured separate from the coupling member 7 and attached thereto, for example by a welded connection.

The hitch ball 11 sits in the ball socket 10, which is rotatable relative to the hitch ball 11 about a vertical axis 28. The vertical axis 28 extends here in the vertical direction 14 of the tractor 1. In addition, the hitch ball 11 is axially secured in the hitch ball joint by an actuatable lock 30. The term “axial” refers here to the direction of the vertical axis 28. A rotation of the coupling lock 9 relative to the hitch ball 11 about the vertical axis 28 thus describes the articulation angle α.

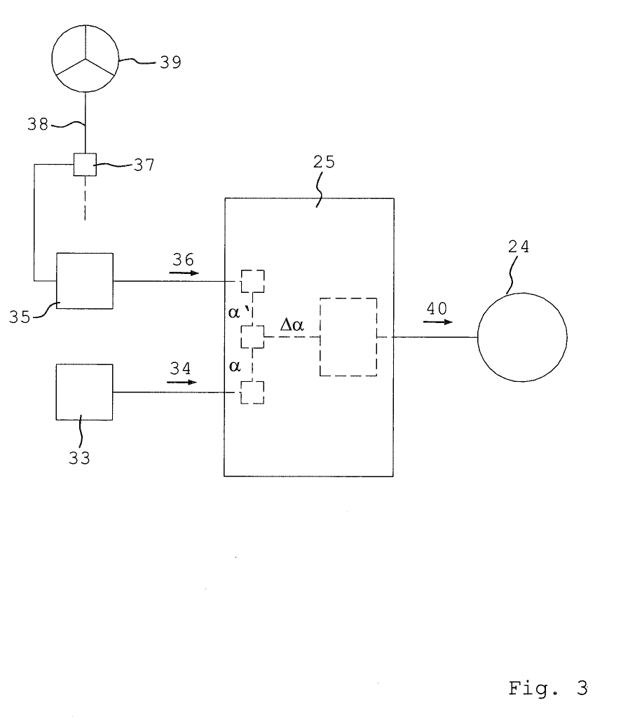

The upper end face of the hitch ball 11 is flattened and has a recess in which a permanent magnet 32, which is rigidly connected with the hitch ball 11, is arranged. The North Pole N and the South Pole S of the magnet 32 are indicated to illustrate its magnetization which extends perpendicular to the vertical axis 28. A magnetic field-sensitive sensor 33, which is spaced from the magnet 32, is attached on the coupling lock 9 above the magnet 32. A rotation of the magnet 32 relative to the coupling lock 9 about the vertical axis 28 can be detected with the magnetic field-sensitive sensor 33. The signal 34 supplied by the sensor 33 (see FIG. 3) has therefore information about the articulation angle α.

FIG. 3 shows schematically the controller 25, which is electrically connected with the motor 24. The magnetic field-sensitive sensor 33 is also electrically coupled with a controller 25 and supplies to the controller 25 the signal characterizing the actual actuation angle α. In addition, the controller 25 is electrically connected with an acquisition device 35 arranged in the tractor 1, which supplies a direction signal 36 to the controller 25. The acquisition device 35 includes a steering wheel angle sensor 37 which is arranged on the steering shaft 38 of the steering wheel 39 of the tractor 1. The direction signal 36 has therefore information about the actual steering wheel angle of the tractor 1, from which a travel direction desired by the operator can be deduced.

When the tractor 1 travels in the reverse direction, i.e., opposite the forward direction 5, the controller 25 evaluates the direction signal 36 to obtain a desired articulation angle α′, which will be referred to as nominal articulation angle. The controller 35 determines from the signal 34 the actual articulation angle α, which is referred to as actual articulation angle. The controller 25 computes from these two angles the difference Δα (Δα=α′−α) as a measure for the deviation between the nominal articulation angle α′ and the actual articulation angle α. Because the articulation angle α can be changed by operating the motor 24, which causes a transverse displacement of the hitch 8, the controller 25 controls the motor 24 with an electric current 40 based on the deviation Δα so as to reduce the absolute magnitude of the deviation Δα. The goal is here to minimize the deviation Δα or to reduce it to zero. The controller hence operates as a regulator. In this way, the trailer 2 can be stabilized during reverse travel in accordance with the direction desired by the operator of the tractor 1.

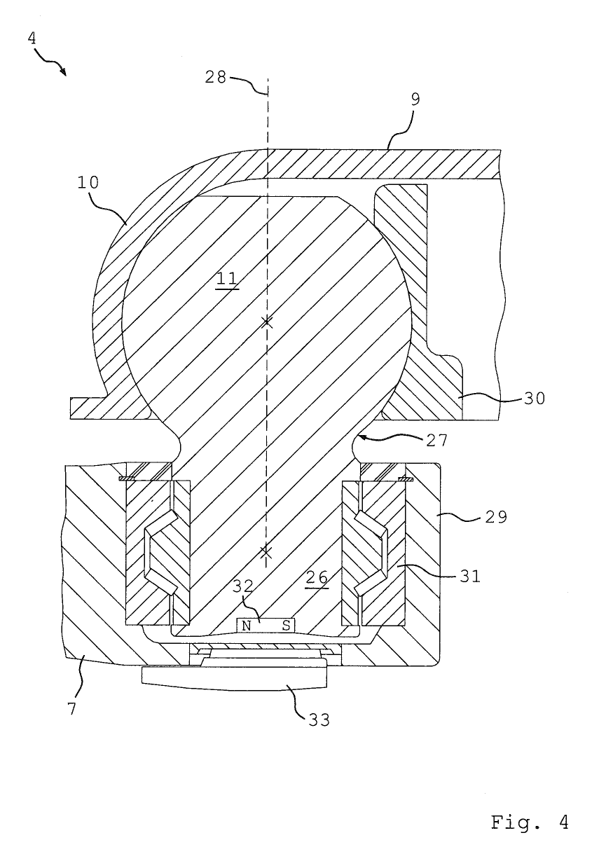

FIG. 4 shows a schematic cross-sectional view of a modified trailer coupling 4, which can replace the trailer coupling illustrated in FIG. 2. Features which are identical or similar for both trailer couplings are indicated with identical reference symbols, corresponding to the trailer coupling in FIG. 2.

A ball pin 27, which includes the hitch ball 11 and a pin 26, is supported in a housing 29 by a rotary bearing 31 for rotation about the vertical axis 28. The housing 29 is arranged at the end of the coupling member 7 and is formed as a single piece therewith. The hitch ball 11 sits in the ball socket 10 and is axially secured in the ball socket 10 by the actuatable lock 30. Because for a rotation about the vertical axis 28, the friction between the hitch ball 11 and the coupling lock 9 is significantly greater than the friction of the rotary bearing 31, rotation of the coupling lock 9 relative to the hitch ball 11 about the vertical axis 28 is prevented by friction. A rotation of the coupling lock 9 relative to the housing 29 about the vertical axis 28 therefore describes the articulation angle α.

A permanent magnet 32, which can rotate together with the ball pin 26 about the vertical axis 28 relative to the housing 29, is rigidly secured on the lower end face of the pin 26. A magnetic field-sensitive sensor 33, which is arranged below and spaced from the magnet 32, is secured on the housing 29, by which a rotation of the magnet 32 relative to the housing 29 about the vertical axis 28 can be measured. The signal 34 supplied by the sensor 33 therefore has information about the articulation angle α.

What is claimed is:

1. A steering arrangement for a trailer, comprising
a hitch (8) connected with a chassis (17) of the trailer (2),
a trailer coupling (4) for coupling the hitch (8) to a tractor (1) in an articulated fashion by forming a tractor/trailer combination (3) including the tractor (1) and the trailer (2),
a drive (24) which is at least indirectly coupled with the trailer coupling (4), by which the articulation angle (a) of the composition (3) is being varied during reverse travel,
a controller (25) coupled with the drive (24), for controlling the drive (24), wherein
the hitch (8) is supported on the chassis (17) for movement in the transverse direction (16) of the trailer (2) and is movable by the drive (24) in the traverse direction relative to the chassis (17).

2. The steering arrangement according to claim 1, wherein one or more control signals (34, 36) can be supplied to the controller (25), so that the hitch (8) is movable by the drive (24) in the transverse direction (16) depending on the control signal(s) (34, 36).

3. The steering arrangement according to claim 2, wherein the one or more control signals (34, 36) comprise one or more direction signals (36), from which the desired articulation angle (a) of the composition (3) can be derived.

4. The steering arrangement according to claim 3, wherein an articulation angle sensor (32, 33) coupled with the controller (25), with which the actual articulation angle (α) of the composition (3) can be acquired and a sensor signal (34) characterizing the actual articulation angle (α) can be supplied as one of the control signals to the controller (25).

5. The steering arrangement according to claim 3, wherein the hitch (8) is moveable by the drive (25) in the transverse direction (16) depending on a deviation (Δα) between the actual and the desired articulation angle.

6. The steering arrangement according to claim 4,
wherein the articulation angle sensor (32, 33) is located on or in the trailer coupling (4).

7. The steering arrangement according claim 4, wherein the articulation angle sensor comprises a magnetic field-sensitive sensor (33) and a magnet (32) movable relative to the sensor (33), wherein one of the sensor and magnet can be non-rotatably coupled to the chassis (6) of the tractor (1) and the other of the magnet and sensor to the hitch (8).

8. The steering arrangement according to claim 3, wherein an acquisition device (35) coupled with the controller (25), with which information for computing a desired travel direction of the combination during reverse travel can be acquired and supplied to the controller (25) in form of the direction signal(s) (36).

9. The steering arrangement according to claim 8, wherein the information for computing a desired travel direction of the combination during reverse travel comprises information about a steering wheel angle of the tractor (1), which can be measured with a steering wheel angle sensor (37) arranged in the tractor.

10. The steering arrangement according to claim 8, wherein the acquisition device (35) comprises the steering wheel angle sensor (37).

11. The steering arrangement according to claim 1, wherein the drive is self-locking.

12. The steering arrangement according to claim 1, wherein the drive comprises an electric motor (24) and a gear (22, 23), by which the electric motor (24) is coupled to the hitch (8).

13. The steering arrangement according to claim 12, wherein the gear comprises a worm gear (22, 23).

14. The steering arrangement according one of the preceding claims, wherein the trailer coupling (4) comprises a hitch ball (11) attached on the chassis (6) of the tractor (1) and a coupling lock (9) attached on the hitch (8), in which the hitch ball (11) can be inserted.
